(19) United States
(12) Patent Application Publication
(10) Pub. No.: US 2021/0271476 A1
(43) Pub. Date: Sep. 2, 2021

(54) METHOD FOR ACCELERATING THE EXECUTION OF A SINGLE-PATH PROGRAM BY THE PARALLEL EXECUTION OF CONDITIONALLY CONCURRENT SEQUENCES

(71) Applicant: COMMISSARIAT A L'ENERGIE ATOMIQUE ET AUX ENERGIES ALTERNATIVES, Paris (FR)

(72) Inventor: Mathieu JAN, Paris (FR)

(73) Assignee: COMMISSARIAT A L'ENERGIE ATOMIQUE ET AUX ENERGIES ALTERNATIVES, Paris (FR)

(21) Appl. No.: 17/260,852

(22) PCT Filed: Jul. 15, 2019
(86) PCT No.: PCT/FR2019/051768

§ 371 Date: Jan. 15, 2021

(30) Foreign Application Priority Data
Jul. 18, 2018 (FR) 1856659

(51) Int. Cl. G06F 9/30; G06F 9/38; G06F 12/0891

(52) U.S. Cl. CPC G06F 9/30072; G06F 12/0891; G06F 9/3836; G06F 9/3004

(57) ABSTRACT

A method for executing a program by a computer system executing sequences of instructions, includes a conditional selection of a sequence of instructions from a satisfied sequence and at least one unsatisfied sequence. The method comprising includes on the execution of a sequence distribution instruction by a first calculation resource, distributing the execution of the satisfied sequence and the at least one unsatisfied sequence between the first calculation resource and at least one second calculation resource. The method also includes parallel execution of the satisfied sequence and of the at least one unsatisfied sequence each by a calculation resource among the first and the at least one second calculation resource. The method further includes, once the satisfied sequence and the at least one unsatisfied sequence are fully executed, continuing the execution of program by a calculation resource among the first and the at least one second calculation resource.

### TECHNICAL FIELD

The field of invention is that of real-time computer systems for which the execution time of tasks, and especially the worst-case execution time (WCET), has to be known in order to ensure validation thereof and guarantee security thereof. More particularly, the invention aims at improving accuracy of the WCET estimate of a program by making it possible to provide a guaranteed WCET without being too pessimistic.

### STATE OF PRIOR ART

Real-time systems have to react reliably, which implies both being certain of the result produced by their programs and knowing how long they take to be executed. Worst-case execution times are thus fundamental data for the validation and safety of such real-time systems, and even more so in the context of autonomous real-time systems (robotics, autonomous car, GPS) for which operational safety is paramount.

However, computing a WCET, both guaranteed (strict upper bound) and not too pessimistic in order to reduce costs and complexity of such real-time systems, is a difficult problem to solve due to the time impact of hardware units executing the programs and the number of possible program execution paths.

The so-called “single-path” code transformation technique makes it possible to make the execution time of a program predictable and thus to provide a reliable WCET. According to this technique, the different code sequences that have selectively to be executed according to the result of a conditional branching that examines input data (also referred to as conditionally competing sequences or even sequences of an alternative because they make up possible choices of an alternative) are brought into a sequential code, relying on capacities of some processors to associate predicates with their assembler instructions to keep the original semantics of the program.

The application of this “single-path” transformation technique thus makes it possible to reduce the combinatorics of possible execution paths of a program by resulting in a single execution path. The measurement of a single execution time of the program thus transformed is therefore sufficient to provide the WCET of the program. This simplifies the measurement approach to determine the WCET because it eliminates the problem of the coverage rate of a program achieved by a measurement run.

However, the use of this “single-path” code transformation technique has the drawback of increasing the execution time of a program since the conditionally competing sequences of an alternative are executed sequentially.

### DISCLOSURE OF THE INVENTION

The purpose of the invention is to provide a technique for eliminating this increase in WCET execution time. To this end, it provides a method for executing a program by a computer system having computational resources capable of executing sequences of instructions, comprising a conditional selection of a sequence of instructions from among a so-called fulfilled sequence and at least one so-called unfulfilled sequence. This method comprises the following steps of:
upon executing a sequence distributing instruction by a first computational resource of the computer system, distributing the execution of the fulfilled sequence and of the at least one unfulfilled sequence between the first computational resource and at least one second computational resource of the computer system;
parallel executing the fulfilled sequence and the at least one unfulfilled sequence each by a computational resource among the first and the at least one second computational resources;
once the fulfilled sequence and the at least one unfulfilled sequence have been completely executed, continuing executing the program by one of the first and at least one second computational resources.

Thus, when a program executed on a computational resource A reaches an instruction of sequence of instructions distribution, one of the fulfilled and unfulfilled sequences is executed on another computational resource B while the other of the fulfilled and unfulfilled sequences is executed on computational resource A. This parallel execution enables WCET of the program to be reduced. The method according to the invention therefore makes it possible to free up additional processor time for either executing additional programs on a same hardware architecture, or selecting a less efficient but more economical hardware architecture for executing a given set of programs. This method therefore makes it possible to optimize the use of computational resources when designing a real-time system requiring the determination of WCET.

Some preferred but not limiting aspects of this method are the following:
distributing execution of the fulfilled sequence and the unfulfilled sequence consists in having the unfulfilled sequence executed by the first computational resource and the fulfilled sequence by the second computational resource;
upon parallel executing the fulfilled sequence and the unfulfilled sequence, a piece of data written in memory by one of the first and second computational resources is subject to a visibility restriction so as to be visible only by the one of the first and second computational resources which carried out writing the piece of data in memory;
it comprises, upon continuing executing the program, terminating the visibility restriction of data written in memory by the computational resource among the first and the second computational resource which executed, upon parallel executing the fulfilled sequence and the unfulfilled sequence, the selected sequence of instructions;
it comprises, upon continuing executing the program, invalidating the data written in memory by the computational resource among the first and second computational resources which did not execute, upon parallel executing the fulfilled sequence and the unfulfilled sequence, the selected sequence of instructions;
each of the first and second computational resources notifies the other of the first and second computational resources about terminating the execution of the one of the fulfilled and unfulfilled sequences it is executing;
continuing executing the program is carried out by the computational resource that has executed the sequence of instructions selected by the conditional selection upon parallel executing the fulfilled sequence and the unfulfilled sequence;
when a maximum permissible number of simultaneous parallel executions of sequences is reached, distributing the execution of the fulfilled sequence and of the at least one unfulfilled sequence between the first computational resource and the at least one second computational resource of the computer system is not carried out and the sequence selected by the conditional selection is executed by the first computational resource;
when the maximum permissible number of simultaneous parallel executions of sequences is reached, the sequences selected and not selected by the conditional selection are executed one after the other by the first computational resource;
it further comprises a step of measuring the execution time of the program and a step of determining a worst-case execution time of the program.

### BRIEF DESCRIPTION OF THE DRAWINGS

Further aspects, purposes, advantages and characteristics of the invention will better appear upon reading the following detailed description of preferred embodiments of the invention, given by way of non-limiting example and with reference to the appended drawings in which:

FIG. 1 illustrates a standard conditional branching structure of the “Test If else” type;

FIG. 2 illustrates the steps of the method according to the invention of distributing the sequences of an alternative and parallel executing them, each by a different computational resource;

FIG. 3 illustrates the steps of the method according to the invention of terminating the parallel execution of the sequences of an alternative and continuing executing the program by a computational resource.

### DETAILED DISCLOSURE OF PARTICULAR EMBODIMENTS

The invention relates to a method for executing a program by a computer system, especially a real-time system, having computational resources capable of executing sequences of instructions. The computer system is, for example, a single-core or multi-core computing processor. The program can especially execute tasks, for example real-time tasks, programmed according to the “single-path” programming technique, the method according to the invention making it possible to accelerate execution of this single-path program.

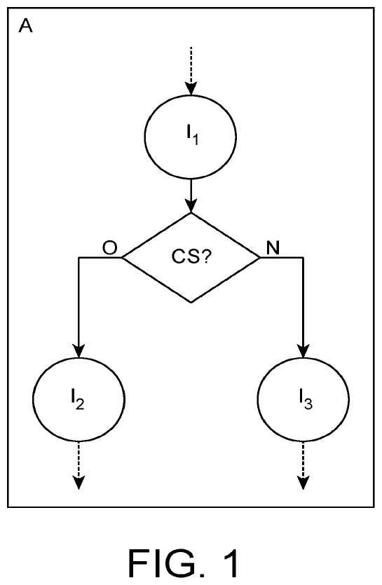

Processing a standard conditional branching structure present within a program P executed by a computational resource A has been represented in FIG. 1. This program consists of three sequences of instructions I₁, I₂ and I₃. Sequence of instructions I₁ ends with a standard conditional branching instruction the execution of which causes the “CS ?” evaluation of the fulfilment of a branching condition and the selection, based on the result of this evaluation, of a sequence of instructions to be executed from among two possible sequences I₂ and I₃. These two possible sequences are conditionally competing (only one is executed, selected depending on the result of the evaluation of fulfilment of the condition) and are subsequently referred to as the fulfilled sequence I₂ (this is the sequence that is executed when the condition is fulfilled, “Y”) and the unfulfilled sequence I₃ (this is the sequence that is executed when the condition is unfulfilled, “N”).

The invention provides a new type of instruction said a conditionally competing sequence distributing instruction (or more simply a distributing instruction in what follows) which, when executed, performs, due to the presence of a conditional selection of one of the sequences, distributing the parallel execution of these different sequences on different computational resources.

The conditional selection can be a selection of the if-then-else type enabling one of two possible sequences of an alternative, a fulfilled sequence and an unfulfilled sequence, to be selected. The invention extends to a conditional selection of the switch type enabling one sequence among a plurality of possible sequences (typically at least three possible sequences), a fulfilled sequence and at least one unfulfilled sequence, to be selected. The following is an example of a selection of the if-then-else type, it being understood that a selection of the switch type can easily be reduced to this example by replacing it with a series of cascading if-then-else type selections.

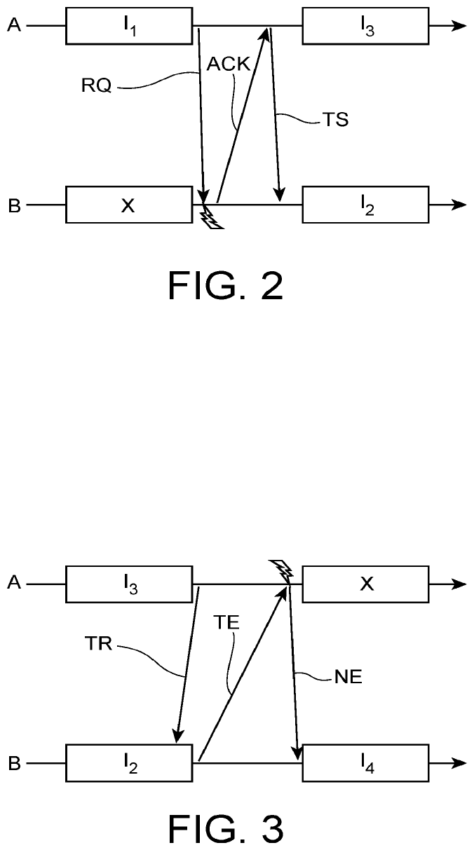

As represented in FIG. 2, program P is initially executed by a first computational resource A and executing the sequence of instructions I includes a conditional selection of a sequence of instructions from among a fulfilled sequence and at least one unfulfilled sequence. This conditional selection may comprise evaluation of fulfilment of a branching condition and the selection, depending on the result of this evaluation, of a sequence of instructions to be executed from among two possible sequences.

The sequence of instructions I₁ ends with a distributing instruction which, when executed by the computational resource A, causes the execution of the fulfilled sequence and the unfulfilled sequence to be distributed between the first computational resource A and a second computational resource B of the computer system different from resource A.

In a possible embodiment, the conditional selection results from the execution, prior to the distributing instruction, of an instruction to test the condition fulfilment. The result of the execution of the test instruction is stored in a status register part of the micro-architecture and the distributing instruction makes use of this information to determine the address at which the program continues, i.e., the address of the sequence selected by the conditional sequence.

In another possible embodiment, the conditional selection results from the execution of the distributing instruction itself. The distributing instruction takes as parameters the registers on which the condition is to be evaluated and the result of this evaluation is directly utilized upon executing the instruction to determine the address at which the program continues, i.e. the address of the sequence selected by the conditional sequence.

In each of these embodiments, the distributing instruction is an enriched branching instruction to designate the second computational resource B. The branching instruction can thus take as an argument the second computational resource B, and in this case, it is upon constructing the binary element that this information has to be produced. Alternatively, the branching instruction can take as an argument a specific register (usable_resources register in the example below) to identify the second computational resource B among a set of usable resources.

As represented in FIG. 2, distributing can consist in having the unfulfilled sequence I₃ executed by the first computational resource A and the fulfilled sequence I₂ by the second computational resource B. The choice of offsetting the fulfilled sequence makes it possible, on the first computational resource A executing the unfulfilled sequence, to continue to preload sequentially instructions of the program and thus to avoid introduction of any chance factor in executing the program at the instruction execution pipeline of a micro-architecture.

Distributing includes an offset request RQ for the execution of one of the fulfilled and unfulfilled sequences, this request being formulated by the first computational resource A to the second computational resource B. When this offset request is accepted ACK by the second computational resource B, the program X that was being executed by the second computational resource B is suspended. This suspension is considered as an interruption in the operation of computational resource B, and the execution context of program X is then saved. A TS transfer, from resource A to resource B, of the state necessary to start executing the fulfilled and unfulfilled sequences that resource B has to execute is performed. This transfer relates to the values of the registers manipulated by program P before the distributing instruction, the current stack structure of program P as well as the identification of computational resource A.

The fulfilled sequence I₂ and the unfulfilled sequence I₃ are then parallel executed, each by a computational resource from among the first resource A and the second resource B.

Once these two sequences I₂ and I₃ have been fully executed, executing the program P continues on a computational resource from among the first resource A and the second resource B.

More particularly, as represented in FIG. 3, program P includes a fourth sequence of instructions 14 which has to be executed once parallel execution of sequences I₂ and I₃ is terminated.

The invention suggests that sequences of instructions I₂ and I₃ each terminate with a parallelism termination instruction. In the example represented, the sequence of instructions I₃ executed by the computational resource A is the first to terminate and executing the parallelism termination instruction causes the computational resource A to notify TR to computational resource B of the termination of the sequence I₃. When the sequence of instructions I₂ executed by the computational resource B terminates, executing the parallelism termination instruction causes the computational resource B to notify the computational resource A of that termination. In this example, resource B has executed the sequence I₂ that turns out to be the sequence selected by the conditional selection (the condition was fulfilled in this case). In this example, executing program P is continued on the computational resource B by executing the instructions of the instruction block I₄, after the resource B has requested TE to resource A to transfer NE the register status to update the same locally.

The computational resource A can then resume executing the program X which was being executed on the computational resource B before parallel executing the fulfilled and unfulfilled sequences I₂ and I₃, by restoring the context of execution of this program since its saving.

Thus, each of the computational resources A and B resorts to this parallelism termination instruction in order, firstly, to wait for the termination of the other sequence so as to keep the temporal predictability property of a program, and then secondly, to determine at which instruction the execution of the program continues. Besides, the parallelism termination instruction results in selecting the computational resource on which execution of the program will continue and in keeping only data produced by the selected sequence.

The distribution and termination instructions provided by the invention can be generated conventionally by a compiler upon constructing a binary element of the program being processed.

It should be noted that it is necessary to carry out all the memory accesses of sequences I₂, I₃ of the alternative to guarantee the temporal predictability of the program execution. Indeed, the knowledge of the sequence selected by the conditional selection cannot be used to eliminate memory accesses of the non-selected sequence because this would cause variations in the execution time of the alternatives.

It was seen that executing program P can continue on either of the computational resources A and B used in the parallel execution of fulfilled and unfulfilled sequences. A first strategy may consist in continuing executing program P on the computational resource which has executed the unfulfilled alternative, which may induce data transfer from the other computational resource if the selected sequence is the fulfilled sequence. As represented in FIG. 3, another strategy may consist in continuing executing program P on the resource that executed the selected sequence to avoid this data transfer.

It will be noted that if a program (such as program X in FIGS. 2 and 3) has been interrupted to allow parallel execution of fulfilled and unfulfilled sequences, the execution context of this program should be restored to allow its execution to continue. If the execution of this program continues on the same computational resource, this restoration may be carried out as soon as the sequence, among the fulfilled and unfulfilled sequences, executed by this computational resource terminates. This restoration can also be carried out at the termination of parallelism, or even later. And as seen previously, this restoration can possibly be performed on the other computational resource involved in parallel execution.

Upon parallel executing the fulfilled and unfulfilled sequences I₂ and I₃, a specific operation of the memory hierarchy storing data manipulated by a program is necessary. Indeed, a same piece of data can be manipulated by both sequences I₂ and I₃. But if read accesses do not pose a problem, write accesses raise the problem of consistency of these data. Thus, write accesses from a computational resource executing one of the sequences of the alternative should not be visible from the computational resource executing the other sequence of the alternative.

To do this, each write access creates a new copy of a piece of data and an identifier of the computational resource being owner of this piece of data is then added to meta-information associated with the piece of data. This identifier is thus used to determine whether a computational resource can access this piece of data. This mechanism for restricting the visibility of data manipulated by a computational resource allows a level of the memory hierarchy shared between computational resources, to be privatised.

Besides, in addition to the need to isolate copies of a piece of data manipulated by the different resources parallel executing the different sequences of an alternative, this piece of data should not be made visible to other programs or, via

Inputs/Outputs (I/O), to the external environment of the system executing the programs. A piece of data having among its meta-information an identifier of a computational resource used to implement the parallel execution of a sequence of an alternative cannot then be updated in a memory for this purpose or to an I/O. This restriction forces the program developer to implement communications to other programs or to I/Os outside the parallel execution of sequences of an alternative.

Optionally, in order to limit intrusion of this data visibility restriction mechanism into the standard operation of a main memory, for example of DRAM type, the use of this mechanism is limited to the memory hierarchy between computational resources and the main memory.

Thus according to the method of the invention, upon parallel executing the fulfilled sequence I₂ and the unfulfilled sequence I₃, a piece of data written in memory by one of the first A and second B computational resources is subject to a visibility restriction in order to be visible only by the one of the first and second computational resources which carried out writing of the piece of data in memory.

In addition, upon continuing the execution of the program after termination of the parallel execution of the sequences of the alternative, the method comprises terminating the visibility restriction of the data written in memory by the computational resource among the first and the second computational resource which executed, upon parallel executing the fulfilled sequence and the unfulfilled sequence, the selected sequence of instructions. These data, those of sequence I₂ executed by resource B in the example in FIG. 3, are thus made visible to all the computational resources.

And by contrast, the method includes, upon continuing executing the program, invalidating data written in memory by the computational resource among the first and second computational resources which did not execute, upon parallel executing the fulfilled sequence and the unfulfilled sequence, the selected sequence of instructions. In the example of FIG. 3, data of the sequence I₃ executed by resource A is thus made invalid.

It is possible to specify, for a given program, a maximum permissible number of simultaneous parallel executions of alternative sequences. This maximum permissible number cannot be greater than the number of computational resources of the hardware architecture in question.

When this maximum permissible number is reached, the sequences of an alternative can no longer be subject to a parallel execution and standard conditional branching instructions (see FIG. 1) should be used. If this use is made upon generating the assembler code of a program by a compiler, then the generated binary element of the program is dependent on this maximum permissible number. If this use is made at hardware execution by substituting the sequence distributing instructions of an alternative, then the generated binary element of the program is independent of the maximum degree of alternative parallelism.

If this maximum permissible number is too small to cover all the alternatives in the program, then the latter consists of several execution paths. A compromise has therefore to be found between the use of computational resources and complexity of a WCET analysis, which is partly related to the number of paths in a program.

In an alternative embodiment, when the program reaches its maximum permissible number of simultaneous parallel executions of sequences of an alternative, the “single-path” code transformation technique can be applied to alternatives which cannot be subject to the distribution according to the invention in order to keep the construction of a single execution path. In such a case, the sequences selected and not selected by conditional selection are executed one after the other by the first computational resource.

The method according to the invention makes it possible not to employ conventional branching prediction units since by construction both sequences of an alternative are executed. No backward transmission for updating the instruction counter in the instruction reading step within a microarchitecture is therefore necessary. However, exploring the choices of the computational resource to be used to continue the execution of the program after completion of the parallel execution of sequences of an alternative can be carried out in order, for example, to reduce WCET of the program.

A possible implementation of the method according to the invention is described below.

A table is associated with each computational resource and each entry in the table contains a current program identifier P, a maximum permissible number of simultaneous parallel executions EPSmax, a counter EPSact of simultaneous parallel executions (initialised to 0) for this program P and two sets with an equal size to the number of computational resources of the hardware architecture.

The first set, called usable_resources, indicates the usable computational resources that can be used for parallel executing the sequences of the alternatives of program P, while the second set, called used_resources, indicates the computational resources currently used by this same program P. Initializing usable_resources is the responsibility of a binary element development phase, whereas used_resources initially contains the computational resource used to start executing program P. An execution without parallelism results in a size of one element for the used_resources set, whereas an execution with parallelism requires that the size of this same set be greater than 1.

Two sets of notification registers also make it possible to indicate, for each computational resource, 1) the first failure of an offset request of a sequence of an alternative, the value of the instruction counter when this request fails (initially 0) and the occurrence of subsequent failures, called the notification field of additional failures, e.g. one bit, (initially invalidated) and 2) the first attempt to overflow the maximum permissible number EPSmax, the value of the instruction counter during this overflow attempt (initially 0) and the occurrence of subsequent overflow attempts, called the notification field of additional overflow attempt (initially invalidated). Optionally, an interrupt mechanism can be used to notify a computational resource of the occurrence of such events.

All this information can be part of the program execution context which has to be saved/restored at each preemption/resumption of program execution.

For each elementary data storage unit in a memory hierarchy, excluding the main memory, the meta-information is completed by information indicating whether the piece of data is overall visible by all the resources (noted overall, by default valid), and an identification of the computational resource being owner of the data (noted owner, by default invalidated). These two elements are used to implement the mechanism for restricting the visibility of data manipulated upon parallel executing the sequences of an alternative.

The steps of the method are then as follows for processing a sequence distributing instruction of an alternative.

Step A-1

When a sequence distributing instruction of a program alternative is decoded by a first computational resource A, the value of the counter EPSact is compared with the maximum permissible number EPSmax.

If these values are identical, the distributing instruction is processed as a conventional conditional branching instruction and this procedure is not implemented. However, all notification registers for the first attempt to exceed the maximum permissible number are updated, with, if it is for the first attempt to exceed the maximum permissible number (identifiable by a value of the instruction counter of 0), the address of the distributing instruction. If this is not the first attempt to exceed, only the notification field of additional overrun attempt is validated. The method then waits for a new distributing instruction before resuming step A-1.

If these values are not identical, a computational resource B usable by this program but not yet used is identified by difference between the usable_resources and usable_resources sets. The method then continues in step A-2.

If no computational resource is identified, the method continues in step A-5.

Step A-2

The computational resource A notifies an offset request of the execution of one of the sequences among the fulfilled and unfulfilled sequences to the computational resource B and waits for a response from the latter. An execution offset request consists of a pair of the identifier of program P and the identifier of computational resource A.

When the offset request is received by the computational resource B, the identifier of the computational resource A sending the request is checked as being part of the computational resources that can send such a request, i.e. whether computational resource A belongs to the used_resources set associated with this program.

If this is the case, the method then continues in step A-3.

If it is not, computational resource B notifies rejection of the offset request to the computational resource A issuing the request. All the registers for notification of an offset request failure for a sequence of an alternative are updated on computational resource A with, if this is the first offset request (identifiable by a value of the instruction counter to 0), the address of the distributing instruction. If it is not the first offset request, only the notification field of additional offset request failure is validated. The method continues in step A-4.

Step A-3

If this offset request is accepted, on the computational resource A side issuing the offset request, the counter EPSact is incremented. Then, the following information is transmitted from computational resource A to computational resource B: all the volatile and non-volatile registers manipulated by the program, the stack pointer, the current stack structure, the identifier of the first computational resource, the value of the counter EPSact, the branching address specified by the alternative distributing instruction as well as the condition value generating selection of one of the sequences of the alternative. These transfers can be implemented in different ways depending on the underlying microarchitecture, e.g. entirely by hardware after executing a memory barrier and appropriate hardware extensions, or via instructions for accessing the registers of computational resource A from computational resource B, or purely via conventional memory access instructions to transfer this information.

All these values are positioned on the computational resource B receiving the offset request, while the registers not manipulated by the program are reinitialised on the same computational resource B.

The method continues execution in step A-6.

Step A-4

If the offset request is not accepted by resource B, resource B is removed from the usable_resources set associated with computational resource A and another usable but not yet used computational resource is identified (in the same way as in step A-1 of the method) and the method then continues in step A-2 on computational resource A.

Resource B may possibly be added later to the usable_resources set associated with computational resource A when conditions are met, such as when the applicative load of resource B is lower or when the system configuration changes and resource B can be used again.

Step A-5

If no computational resource is identified, execution of the program continues without using the method according to the invention. The distributing instruction is then processed as a conventional conditional branching instruction. On the other hand, all the notification registers of an offset request failure are updated with, if this is the first offset attempt for this program (identifiable by a value of the instruction counter to 0), the address of the alternative distributing instruction. If this is not the first attempt, only the additional offset request failure notification field is validated. The method then waits for a new distributing instruction to resume step A-1.

Step A-6

The value of the instruction counter of computational resource A, issuing an offset request, is positioned to the next instruction and execution of the unfulfilled alternative continues on computational resource B, receiving an offset request alternative, to the instruction specified in the distributing instruction.

On each of both computational resources, the usable resources set is updated to include computational resource B, having accepted the offset request.

The method steps are as follows upon parallel executing the sequences of the alternative (identifiable by the fact that the counter EPSact has a value greater than 1). Apart from these steps, no manipulated piece of data can have its owner field valid.

Step B-1

For each execution of an instruction generating a write memory access from a computational resource A or B, a new copy of the modified piece of data is inserted in the memory hierarchy and the fields of its overall and owner meta-information are respectively invalidated and positioned at the identifier of the computational resource A or B. When the memory hierarchy relies on caches, the update strategy (whether immediate or deferred) relates only to these caches and therefore excludes an impact on the main memory or on I/Os in order to avoid any inconsistent data being made available to other programs or to the external environment. To do this, the mechanism for updating a cache on the last level of the memory hierarchy is deactivated when the overall and owner fields are respectively invalidated and positioned at the identifier of a computational resource. This rule for a write access can only be applied for an access to the first shared level of a memory hierarchy, if no hardware consistency is ensured between private levels of the memory hierarchy.

Step B-2

For each execution of an instruction generating a read memory access to the first level of the memory hierarchy of a computational resource A, and before any transmission of the request to the higher level of the memory hierarchy of computational resource A, the request is transmitted to the first level of the memory hierarchy of the other computational resource B used in that level of parallel execution of sequences of an alternative.

An alternative is to carry out this transmission in parallel with the transmission of the request to the first level of the memory hierarchy of computational resource A, however this increases the worst case latency of a memory request from a computational resource. A compromise can be explored to allow such simultaneity for a number of hardware cycles and reduce the latency of such memory accesses made by the second computational resource.

Another alternative is to transmit requests in parallel to all the first levels of the memory hierarchy of the computational resources used by the program (those identified by the used_resources set).

All these alternatives are applicable to switch from level n to level n+1 of a memory hierarchy. The memory request of a computational resource A can only look up the data whose fields of its overall and owner meta-information are respectively valid and invalidated (piece of data modified by no other sequence of an alternative) or respectively invalidated and equal to the identifier of the computational resource A (piece of data having been previously modified by the sequence being executed on the computational resource A).

The method steps for processing the parallelism termination instruction are as follows.

Step C-1

When an alternative termination instruction is decoded by a computational resource A, the termination information of this alternative is transmitted to the computational resource B involved in parallel execution. If computational resource B has not terminated execution of the sequence assigned thereto, computational resource A then waits for the notification of termination by computational resource B.

Step C-2

Computational resource A then inspects the evaluation value of the condition (for example, calculated upon executing the distributing instruction, or using the status register of computational resource A) to determine whether the sequence it has just executed corresponds to the sequence selected by the conditional selection.

If this is the case, computational resource A propagates a request to the memory hierarchy to make valid the overall field present in the meta-information associated with each piece of data modified during parallel execution, identifiable by the fact that the owner field is positioned at the identifier of computational resource A. The owner field is also invalidated when processing this request.

If it is not, computational resource A propagates a request to conventionally invalidate the data modified during parallel execution, identifiable by the fact that the owner field is positioned at the identifier of computational resource A. This latter field is also invalidated and the global field is reinitialised. In addition, the pipeline is emptied, the memory zone used by the stack of resource A is invalidated.

Step C-3

On each computational resource, the counter ESPmax is decremented and the computational resource that is not retained to continue execution is removed from the used_resources set.

If the computational resource chosen to continue executing the program has not executed the selected sequence, the execution context of the selected sequence (all the volatile and non-volatile registers manipulated by the program, the stack pointer, the complete stack structure) has to be transferred from the computational resource having executed this selected sequence. In addition, data manipulated by the program and stored in private levels of the memory hierarchy associated with the computational resource that executed the selected sequence have to be propagated to the first level shared between both computational resources of the memory hierarchy. Regardless of the choice of computational resource, if the notification registers associated with two computational resources, used in the parallel execution that is terminating, notify the first offset request failures or attempt to exceed failures, only the additional notification fields associated with these events are validated on the computational resource selected to continue executing the program. Otherwise, each notification register associated with the computational resource selected to continue the execution of the program is updated with information from the other computational resource used.

Finally, the value of the instruction counter of the computational resource selected to continue the execution of the program is positioned to the jump address specified in the parallelism termination instruction. On the computational resource that has not been selected to continue execution of the program, a parallel termination interrupt is notified, for example to allow resumption of execution of other programs.

It should be noted that this step C-3 can be anticipated in step C-2 in order to possibly reduce the additional cost of this notification by parallelizing its execution while waiting for parallelism termination. To avoid any inconsistency in the values manipulated by the other sequences of the alternative, this anticipation has to be carried out on data not used by these same sequences being executed.

The method as previously described includes a step of measuring the program execution time and a step of determining a WCET of the program. The invention is not limited to the method as previously described but also extends to a computer program product comprising program code instructions, especially the previously described instructions of sequence distribution and parallelism termination, which, when the program is executed by a computer, cause the computer to implement this method.

1. A method of executing a program by a computer system having computational resources capable of executing sequences of instructions, conditional selection of a sequence of instructions from among a so-called fulfilled sequence and at least one so-called unfulfilled sequence, the method being comprising the steps of:
conditionally selecting a sequence of instructions from among a so-called fulfilled sequence and at least one so-called unfulfilled sequence,
upon executing a sequence distribution instruction by a first computational resource of the computer system, distributing execution of the fulfilled sequence and of the at least one unfulfilled sequence between the first computational resource and at least one second computational resource of the computer system;
parallel executing the fulfilled sequence and the at least one unfulfilled sequence each by a computational resource from among the first and the at least one second computational resources;
once the fulfilled sequence and the at least one unfulfilled sequence have been completely executed, continuing executing the program by a computational resource from among the first and the at least one second computational resources.

2. The method according to claim 1, wherein distributing execution of the fulfilled sequence and of the at least one unfulfilled sequence consists in having the unfulfilled sequence executed by the first computational resource.

3. The method according to claim 1 wherein, upon parallel executing the fulfilled sequence and the unfulfilled sequence, a piece of data written in memory by one of the first and at least one second computational resources is subject to a visibility restriction so as to be visible only by the one of the first and the at least one second computational resources which carried out writing the piece of data in memory.

4. The method according to claim 3 comprising, upon continuing executing the program, terminating the visibility restriction of data written into memory by the computational resource among the first and the at least one second computational resources which executed, upon parallel executing the fulfilled sequence and the at least one unfulfilled sequence, the selected sequence of instructions.

5. The method according to claim 3 comprising, upon continuing executing the program, invalidating the data written in memory by the computational resource among the first and the at least one second computational resources which did not execute, upon parallel executing the fulfilled sequence and the at least one unfulfilled sequence, the sequence of instructions selected by the conditionally selecting.

6. The method according to claim 1 wherein each of the first and at least one second computational resources notifies the other of the first and the at least one second computational resources of the termination of execution of the one of the fulfilled and the at least one unfulfilled sequences it is executing.

7. The method according to claim 1 wherein continuing executing the program is performed by the computational resource having executed the sequence of instructions selected by the conditionally selecting upon parallel executing the fulfilled sequence and the at least one unfulfilled sequence.

8. The method according to claim 1 wherein, when a maximum permissible number of simultaneous parallel executions of sequences is reached, distributing the execution of the fulfilled sequence and the at least one unfulfilled sequence between the first computational resource and the at least one second computational resource of the computer system is not performed and the sequence of instructions selected by the conditionally selecting is executed by the first computational resource.

9. The method according to claim 8 wherein, when the maximum permissible number of simultaneous parallel executions of sequences is reached, the sequences of instructions selected and not selected by the conditionally selecting are executed one after the other by the first computational resource.

10. The method according to claim 1, further comprising a step of measuring the execution time period of the program and a step of determining a worst-case execution time of the program.

11. A non-transitory computer-readable medium comprising program code instructions which, when the program is executed by a computer, cause the computer to implement the method according to claim 1.
